(19) United States
(12) Patent Application Publication
(10) Pub. No.: US 2024/0123852 A1
(43) Pub. Date: Apr. 18, 2024

(54) INFORMATION PROCESSING METHOD

(71) Applicant: TOYOTA JIDOSHA KABUSHIKI KAISHA, Aichi-ken (JP)

(72) Inventors: Kazuyuki INOUE, Nagoya-shi (JP); Jean-Sebastien BOIRE, Yokohama-shi (JP); Kiyonori YOSHIDA, Toyota-shi (JP); Ai MIYATA, Hirakata-shi (JP); Yuki TATSUMOTO, Seto-shi (JP)

(21) Appl. No.: 18/486,159

(22) Filed: Oct. 13, 2023

(30) Foreign Application Priority Data
Oct. 18, 2022 (JP) 2022-167195

(51) Int. Cl. B60L 53/54; B60L 53/57; B60L 58/30; H01M 8/0444; H01M 8/04858; H01M 10/44

(52) U.S. Cl. CPC B60L 53/54; B60L 53/57; B60L 58/30; H01M 8/04447; H01M 8/04925; H01M 10/44; H01M 2220/20; H01M 2250/20

(57) ABSTRACT

An information processing method by an information processing apparatus, the information processing method includes identifying a first vehicle capable of supplying electric power generated by a fuel cell to the outside, and controlling electrical energy to be supplied to the outside according to the amount of hydrogen remaining in the first vehicle and a distance to the next hydrogen station.

### CROSS-REFERENCE TO RELATED APPLICATION

This application claims priority to Japanese Patent Application No. 2022-167195, filed on Oct. 18, 2022, the entire contents of which are incorporated herein by reference.

### TECHNICAL FIELD

The present disclosure relates to an information processing method.

### BACKGROUND

Vehicles that store electric power generated by fuel cells and supply the stored electric power to devices outside the vehicles are known (e.g., Patent Literature (PTL) 1).

### CITATION LIST

### Patent Literature

PTL 1: JP 2021-057942 A

### SUMMARY

The above background technology does not take into account optimal electric power supply to the outside by fuel cell electric vehicles (FCEVs) used in logistics.

It would be helpful to optimize the amount of charge.

An information processing method according to an embodiment of the present disclosure is an information processing method by an information processing apparatus, the information processing method including:
identifying a first vehicle capable of supplying electric power generated by a fuel cell to the outside; and
controlling electrical energy to be supplied to the outside according to the amount of hydrogen remaining in the first vehicle and a distance to the next hydrogen station.

According to an embodiment of the present disclosure, the amount of charge can be optimized.

### BRIEF DESCRIPTION OF THE DRAWINGS

In the accompanying drawings:

FIG. 1 is a schematic diagram of an information processing system according to the present embodiment;

FIG. 2 is a block diagram illustrating a configuration of an information processing apparatus;

FIG. 3 is a block diagram illustrating a configuration of a first vehicle;

FIG. 4 is a block diagram illustrating a configuration of a second vehicle;

FIG. 5 is a diagram illustrating a data structure of a vehicle database; and

FIG. 6 is a flowchart illustrating operations of the information processing apparatus.

### DETAILED DESCRIPTION

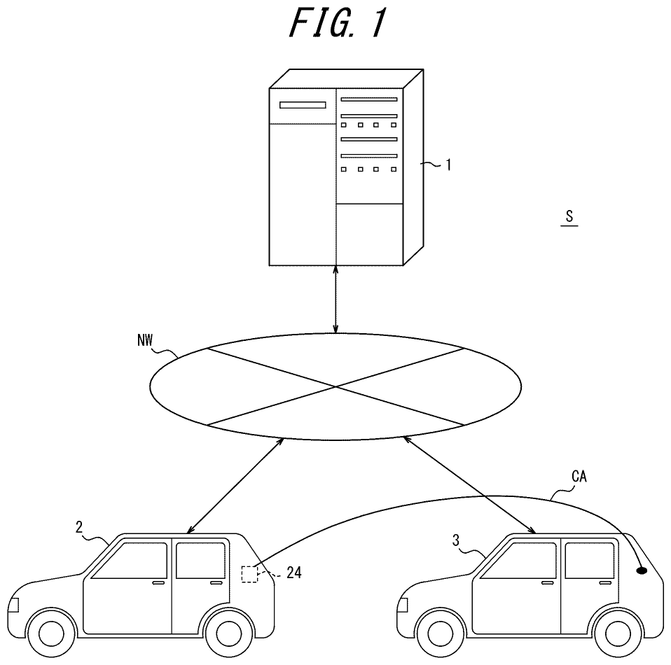

FIG. 1 is a schematic diagram of an information processing system S according to the present embodiment. The information processing system S includes an information processing apparatus 1, a first vehicle 2, and a second vehicle 3. The information processing apparatus 1 can communicate with the first vehicle 2 and the second vehicle 3 via a network NW. The network NW includes, for example, a mobile communication network, the Internet, or a fixed communication network.

FIG. 1 illustrates one each of the information processing apparatus 1, the first vehicle 2, and the second vehicle 3 for convenience of explanation. However, the numbers of information processing apparatuses 1, first vehicles 2, and second vehicles 3 are not limited to this. For example, processing to be executed by the information processing apparatus 1 may be executed by a plurality of distributed information processing apparatuses 1.

The information processing apparatus 1 may be a server configured to assist a provider in providing a service. The information processing apparatus 1 may be, for example, installed in a facility dedicated to the provider or in a shared facility including a data center. As an alternative example, the information processing apparatus 1 may be mounted in the first vehicle 2 or the second vehicle 3. The information processing apparatus 1 may be referred to as a center server.

The first vehicle 2 or the second vehicle 3 includes, for example, any type of automobile such as a gasoline vehicle, a diesel vehicle, an HEV, a PHEV, a BEV, or an FCEV. The term “HEV” is an abbreviation of hybrid electric vehicle. The term “PHEV” is an abbreviation of plug-in hybrid electric vehicle. The term “BEV” is an abbreviation of battery electric vehicle. The term “FCEV” is an abbreviation of fuel cell electric vehicle. The driving of the first vehicle 2 may be automated at any level. The automation level is, for example, any one of Level 1 to Level 5 according to the level classification defined by SAE. The name “SAE” is an abbreviation of Society of Automotive Engineers. The first vehicle 2 may be a MaaS-dedicated vehicle. The term “MaaS” is an abbreviation of Mobility as a Service. Alternatively, the first vehicle 2 may be driven by a driver.

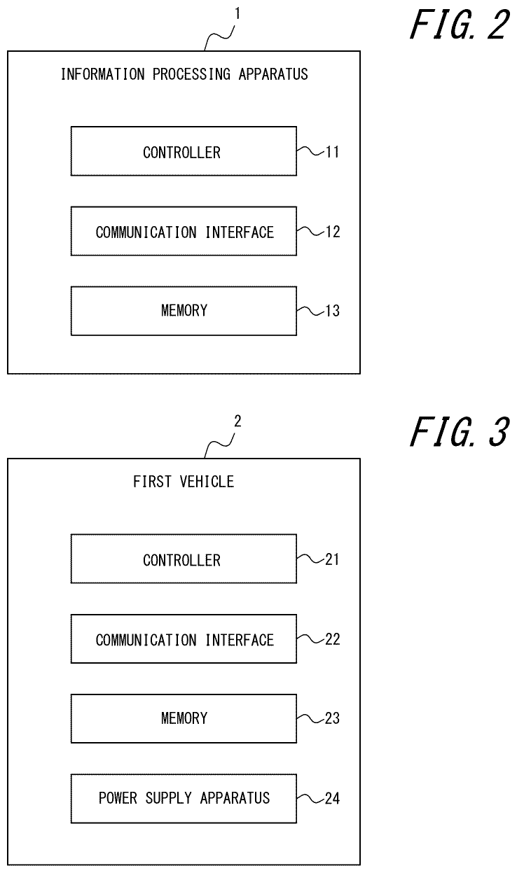

With reference to FIG. 2, an internal configuration of the information processing apparatus 1 will be described in detail.

The information processing apparatus 1 includes a controller 11, a communication interface 12, and a memory 13. The components of the information processing apparatus 1 are communicably connected to one another via, for example, dedicated lines.

The controller 11 includes, for example, one or more general purpose processors including a Central Processing Unit (CPU) or a Micro Processing Unit (MPU). The controller 11 may include one or more dedicated processors that are dedicated to specific processing. The controller 11 may include one or more dedicated circuits instead of the processors. Examples of the dedicated circuits may include a Field-Programmable Gate Array (FPGA) and an Application Specific Integrated Circuit (ASIC). The controller 11 may include an Electronic Control Unit (ECU).

The communication interface 12 includes, for connecting to a network, one or more communication modules that conform to wired or wireless LAN (Local Area Network) standards. The communication interface 12 may include a module conforming to one or more mobile communication standards including the Long Term Evolution (LTE) standard, the 4th Generation (4G) standard, or the 5th Generation (5G) standard. The communication interface 12 may include one or more communication modules conforming to near field communication standards or specifications, including Bluetooth® (Bluetooth is a registered trademark in Japan, other countries, or both), AirDrop® (AirDrop is a registered trademark in Japan, other countries, or both), IrDA, ZigBee® (ZigBee is a registered trademark in Japan, other countries, or both), Felica® (Felica is a registered trademark in Japan, other countries, or both), or RFID. The communication interface 12 transmits and receives any information via the network.

The memory 13 includes, for example, a semiconductor memory, a magnetic memory, an optical memory, or a combination of at least two of these, but is not limited to these. The semiconductor memory is, for example, RAM or ROM. The RAM is, for example, SRAM or DRAM. The ROM is, for example, EEPROM. The memory 13 may function as, for example, a main memory, an auxiliary memory, or a cache memory. The memory 13 may store information resulting from analysis or processing performed by the controller 11. The memory 13 may store various types of information or the like regarding operations and control of the information processing apparatus 1. The memory 13 may store a system program, an application program, embedded software, and the like. The memory 13 may be provided outside the information processing apparatus 1 and accessed by the information processing apparatus 1. The memory 13 includes a vehicle database.

With reference to FIG. 3, an internal configuration of the first vehicle 2 will be described in detail. The first vehicle 2 according to the present embodiment is an FCEV. As an example, in a case in which a hydrogen tank of the first vehicle 2 is full, electric power for four or five days in a typical household is generated.

The first vehicle 2 includes a controller 21, a communication interface 22, a memory 23, and a power supply apparatus 24. The components of the first vehicle 2 are communicably connected to one another, for example, via dedicated lines.

Descriptions of the hardware configurations of the controller 21, the communication interface 22, and the memory 23 may be the same as the descriptions of the hardware configurations of the controller 11, the communication interface 12, and the memory 13, respectively. An explanation here is omitted.

The power supply apparatus 24 can supply electric power generated by a fuel cell of the first vehicle 2 to the outside second vehicle 3 via a cable CA illustrated in FIG. 1.

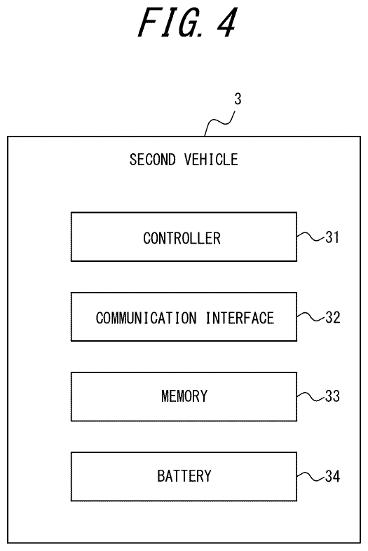

With reference to FIG. 4, an internal configuration of the second vehicle 3 will be described in detail. The second vehicle 3 according to the present embodiment is a BEV.

The second vehicle 3 includes a controller 31, a communication interface 32, a memory 33, and a battery 34. The components of the second vehicle 3 are communicably connected to one another, for example, via dedicated lines.

Descriptions of the hardware configurations of the controller 31, the communication interface 32, and the memory 33 may be the same as the descriptions of the hardware configurations of the controller 11, the communication interface 12, and the memory 13, respectively. An explanation here is omitted.

Hereinafter, processing executed in the information processing system S according to the present embodiment will be described in detail.

Here, as an example, the controller 11 of the information processing apparatus 1 identifies the first vehicle 2 that is capable of supplying electric power generated by the fuel cell to the outside. The controller 11 may determine that electric power supply is performed when the first vehicle 2 is traveling or stopped. The load of the electric power supply is lower when the first vehicle 2 is stopped than when the first vehicle 2 is traveling.

The controller 11 determines the second vehicle 3 as a destination of the electric power supply. The controller 11 determines to charge the battery 34 of the second vehicle 3 with the electric power. A method of determining the second vehicle 3 is arbitrary. As an alternative example, the destination of the electric power supply may be a charging station or an electrically assisted bicycle, instead of the second vehicle 3.

A point at which the electric power supply (charging) is performed may be a rest station or an arrival point on the way of the first vehicle 2 during moving or the second vehicle 3 during moving.

The controller 11 controls (adjusts) electrical energy to be supplied to the outside according to the amount of hydrogen remaining in the first vehicle 2 and a distance to the next hydrogen station. For example, the controller 11 may control the electrical energy to be supplied so that the amount of hydrogen remaining in the first vehicle 2 becomes zero (i.e., hydrogen is used up). For example, in a case in which the first vehicle 2 is a vehicle making a delivery, the controller 11 may control the electrical energy to be supplied to the outside of the first vehicle 2 so that the amount of hydrogen remaining becomes zero after the first vehicle 2 has traveled a remaining delivery distance. As an alternative example, the controller 11 may control the electrical energy to be supplied to the outside of the first vehicle 2 so that the amount of hydrogen remaining becomes zero after the first vehicle 2 has traveled a distance to the next hydrogen station. As another alternative example, in a case in which there is no hydrogen station near a destination and hydrogen refueling is not possible, the controller 11 may control the electrical energy to be supplied to the outside so that the first vehicle 2 can travel home (i.e., not run out of hydrogen on the way home).

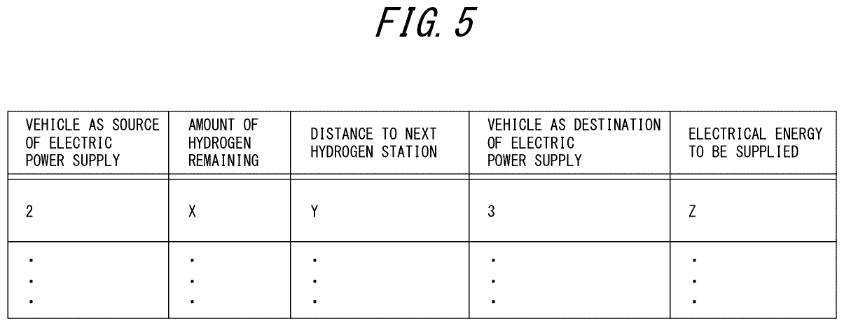

As illustrated in FIG. 5, the controller 11 stores the amount of hydrogen remaining in the first vehicle 2, a distance to the next hydrogen station, identification information on the second vehicle 3 as a destination of electric power supply, and electrical energy to be supplied to the second vehicle 3, in association with the first vehicle 2 as a source of the electric power supply.

The first vehicle 2 that is an FCEV may carry the second vehicle 3 that is a BEV. In other words, the first vehicle 2 carries the second vehicle 3 in a certain section, and the first vehicle 2 and the second vehicle 3 are disconnected in another section.

When the electric power is supplied to the outside, the electric power may be converted from direct current to alternating current.

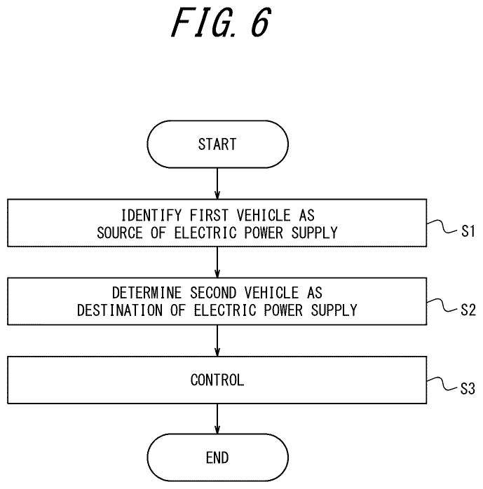

An information processing method by the information processing apparatus 1 will be described with reference to FIG. 6.

In step S1, the controller 11 of the information processing apparatus 1 identifies the first vehicle 2 as a source of electric power supply. In step S2, the controller 11 determines the second vehicle 3 as a destination of the electric power supply. In step S3, the controller 11 controls electrical energy to be supplied to the outside according to the amount of hydrogen remaining in the first vehicle 2 and a distance to the next hydrogen station. Step S2 may be performed before step S1 or after step S3.

As described above, according to the present embodiment, operations of the controller 11 of the information processing apparatus 1 include identifying the first vehicle 2 capable of supplying electric power generated by the fuel cell to the outside, and controlling electrical energy to be supplied to the outside according to the amount of hydrogen remaining in the first vehicle 2 and a distance to the next hydrogen station. With this configuration, the information processing apparatus 1 can optimize the amount of charge.

According to the present embodiment, the operations of the controller 11 also include determining to charge the battery 34 of the second vehicle 3, which is a BEV, with the electric power generated in the first vehicle 2. With this configuration, the information processing apparatus 1 can optimize the amount of charge to the second vehicle 3.

According to the present embodiment, the operations of the controller 11 also include determining that electric power supply is to be performed when the first vehicle 2 is stopped. With this configuration, the information processing apparatus 1 can reduce a load of the electric power supply on the first vehicle 2.

According to the present embodiment, the operations of the controller 11 also include controlling the electrical energy so that the amount of hydrogen remaining in the first vehicle 2 becomes zero. With this configuration, the information processing apparatus 1 can increase efficiency in the next hydrogen refueling of the first vehicle 2.

According to the present embodiment, the operations of the controller 11 include controlling the electrical energy so that the amount of hydrogen remaining becomes zero after the first vehicle 2 has traveled a remaining delivery distance. With this configuration, the information processing apparatus 1 can reduce the risk of hydrogen shortage on the first vehicle 2 on the way of traveling the remaining delivery distance.

While the present disclosure has been described with reference to the drawings and examples, it should be noted that various modifications and revisions may be implemented by those skilled in the art based on the present disclosure. Other modifications can be made without departing from the spirit of the present disclosure. For example, functions or the like included in each means or each step can be rearranged without logical inconsistency, and a plurality of means or steps can be combined into one or divided.

For example, in the aforementioned embodiment, a program configured to execute all or some of the functions or processing of the information processing apparatus 1 can be recorded on a computer readable recording medium. The computer readable recording medium includes a non-transitory computer readable medium and is, for example, a magnetic recording apparatus, an optical disc, a magneto-optical recording medium, or a semiconductor memory. The program is distributed, for example, by selling, transferring, or lending a portable recording medium such as a Digital Versatile Disc (DVD) or a Compact Disc Read Only Memory (CD-ROM) on which the program is recorded. The program may also be distributed by storing the program in a storage of any server and transmitting the program from any server to another computer. The program may be provided as a program product. The present disclosure can also be implemented as a program executable by a processor.

A computer temporarily stores in a main memory, for example, the program recorded on the portable recording medium, or the program transferred from the server. Then, the computer reads the program stored in the main memory using a processor, and executes processes in accordance with the read program using the processor. The computer may read the program directly from the portable recording medium, and execute processes in accordance with the program. The computer may, each time a program is transferred from the server to the computer, sequentially execute processes in accordance with the received program. Instead of transferring the program from the server to the computer, processes may be executed by a so-called ASP type service that realizes functions only by execution instructions and result acquisitions. The term “ASP” is an abbreviation of application service provider. The program encompasses information that is to be used for processing by an electronic computer and is thus equivalent to a program. For example, data that is not a direct command to a computer but has a property that regulates processing of the computer is “equivalent to a program” in this context.

1. An information processing method by an information processing apparatus, the information processing method comprising:
identifying a first vehicle capable of supplying electric power generated by a fuel cell to outside; and
controlling electrical energy to be supplied to the outside according to an amount of hydrogen remaining in the first vehicle and a distance to a next hydrogen station.

2. The information processing method according to claim 1, comprising determining to charge a battery of a second vehicle with the electric power generated in the first vehicle, the second vehicle being a battery electric vehicle.

3. The information processing method according to claim 1, comprising determining that supply of the electric power is performed when the first vehicle is stopped.

4. The information processing method according to claim 1, comprising controlling the electrical energy so that the amount of hydrogen remaining in the first vehicle becomes zero.

5. The information processing method according to claim 4, comprising controlling the electrical energy so that the amount of hydrogen remaining becomes zero after the first vehicle has traveled a remaining delivery distance.
